(19) United States
(12) Patent Application Publication
(10) Pub. No.: US 2016/0159483 A1
(43) Pub. Date: Jun. 9, 2016

(54) SAFETY BELT FOR AIRCRAFT HAVING PROTECTIVE EFFECT AGAINST RADIATION

(71) Applicant: Eckehard KRASKA, Gröbenzell (DE)

(72) Inventor: Eckehard KRASKA, Grobenzell (DE)

(21) Appl. No.: 14/905,957

(22) PCT Filed: Apr. 3, 2014
(86) PCT No.: PCT/EP2014/056692

§ 371 Date: Jan. 18, 2016

(30) Foreign Application Priority Data
Jul. 19, 2013 (DE) 10 2013 214 186.6

(51) Int. Cl. B64D 11/06; B64D 25/06

(52) U.S. Cl. CPC B64D 11/062; B64D 25/06

(57) ABSTRACT

The invention relates to the problem of exposure of passengers and crew members of aircraft to cosmic radiation. To reduce the radiation exposure, a safety belt is described, which has a protective effect against cosmic radiation, wherein the belt is combined with a cosmic radiation absorbing material or such material is incorporated into the belt, and wherein the cosmic radiation absorbing material contains boron or a boron-containing material. A corresponding method for the production of a safety belt for passengers and crew members of aircraft is also described.

Thereby, an effective means to protect the passengers and crew members of aircraft against cosmic radiation is provided, which can be implemented without affecting air traffic and without serious economic consequences for commercial aviation.

### FIELD OF THE INVENTION

The invention relates to a safety belt for passengers and crew members of aircraft, which has a protective effect against cosmic radiation.

### BACKGROUND OF THE INVENTION

The earth is constantly hit by a high-energy particle radiation from space (cosmic rays). On entering the Earth's atmosphere at an altitude of about 20 km above ground, the cosmic rays produce particle showers. The cosmic rays and the particle showers are referred to herein as cosmic radiation. Neutron radiation is the predominant portion of the continuous portion of the cosmic radiation.

Cosmic radiation is shielded by the Earth's atmosphere and the Earth's magnetic field. Thus, at high altitudes it occurs significantly more intensely than at sea level.

The people on board aircraft are exposed to cosmic radiation. Cosmic radiation is relevant from a flying altitude of about 9 km, i.e. the altitudes of today's global air traffic. The measurability of terrestrial radiation becomes less relevant from this level while the intensity of cosmic radiation increases with increasing height. From a flying altitude of about 10 km (30,000 ft), a doubling of the intensity of cosmic radiation is observed at a height increase of about 1,500 m (5,000 ft). In recent years, the maximum altitudes have moved up by around 3,000 m (10,000 ft). Similarly, the required distance between the flight levels above about 9,000 m (29,000 ft) has been reduced from the previous about 600 m (2,000 ft) to about 300 m (1,000 ft). As a result, global air traffic has thus shifted to a considerable degree to more radiation-intensive heights.

In recent years there has been a sharp increase in global air traffic (number of passengers transported globally in 2008: 2 billion; doubling in 15 years). Meanwhile, the proportion of women among business travelers increases because of a more equal social role of women. Female crew members are now the norm in the cabin and often represented in the cockpit.

Cosmic radiation is harmful to humans. Therefore, for example, according to legislation meanwhile adopted, a calculated radiation exposure based on flight hours is to be taken into account in the planning of crew deployment in commercial aircraft.

The reproductive organs of humans (especially the ovaries of women and men's testicles) are particularly sensitive to any additional radiation exposure. The ovaries of women have to be considered as particularly critical since there is no renewal or replacement of the inventory of the ovaries during the lifetime of a woman.

It is to be assumed that the exposure of the ovaries of women to cosmic radiation onboard aircraft leads to an increased incidence of malformations in children of the exposed women (even if it is hardly possible in an individual case to establish a causal relationship between an observed damage or deformity and the previous exposure).

Given the high number of people affected, any measure of protection against cosmic radiation is of relevance and highly desirable from ethical, health and social viewpoints, even if the benefit cannot be proven individually because it is statistically concealed and small. Because even if the protection initially relates to the female ovaries, actually it is newborn life that is protected from damage.

Nevertheless—despite generally greatest technical efforts being made in the field of commercial aviation—currently all measures to protect people, especially the female passengers on board aircraft against cosmic radiation are lacking.

The use of safety belts in the form of lap belts, which are closed with a buckle, is generally obligatory for passengers of commercial aircraft. Crew members in the cockpit use safety belts in the form of 5-point belts, comprising a lap belt (with buckle). The cabin crew uses belts in special flight situations (takeoff, landing, strong turbulence, breaks).

### DESCRIPTION OF THE INVENTION

The object of the invention is to provide effective measures to protect passengers and crew members of aircraft against cosmic radiation, which can be implemented without adversely affecting air traffic and without serious economic consequences for commercial aviation. In particular, the ovaries of women are to be protected onboard aircraft to statistically reduce genetic damage caused by cosmic radiation.

According to the invention, it is proposed to modify the known safety belt system of commercial aircraft such that (1) the safety belt at least partially absorbs the comic radiation and possibly also (2) the design of the belt, in particular its shape, is changed such that the belt can best shield the reproductive organs of the passengers or crew members, especially the ovaries of women.

The invention thus provides a safety belt for passengers and crew members of aircraft, which has a protective effect against cosmic radiation, wherein the belt is combined with a cosmic radiation absorbing material or such material is incorporated into the belt, and wherein the cosmic radiation absorbing material contains boron or a boron-containing material.

Furthermore, the invention provides a method for manufacturing safety belts for passengers and crew members of aircraft, wherein the belt is combined with a cosmic radiation absorbing material or such material is incorporated into the belt, and wherein the cosmic radiation absorbing material contains boron or a boron-containing material.

Thus, the invention also comprises the use of boron or a boron-containing material for the manufacture of safety belts for passengers and crew members of aircraft.

A first aspect of the invention is to provide the safety belt with a proofing that absorbs the cosmic radiation, especially the neutron component thereof, at least partially, and certainly stronger than conventional safety belts for passengers and crew members of aircraft.

This is achieved by combining the safety belt with a material specially absorbing cosmic radiation or by incorporating such a material into the belt. As cosmic radiation absorbing material, boron and boron-containing materials are used, because boron has a relatively large effective cross-section for neutrons.

Since boron is heat-resistant and is already used in aviation, boron and boron-containing materials meet, in particular, the existing strict requirements regarding fire resistance. Suitable boron-containing materials, in particular boron fibers, are commercially available, for example, from Specialty Materials, Inc. (Massachusetts, USA; see http://specmaterials.com). Boron is also commercially available in powder form and embedded in films.

According to the invention, a film or a fabric of or having a cosmic radiation absorbing material can be combined with, e.g. laminated with or sewn onto, the belt. Such a material can also be directly incorporated into the material from which the belt is made. For example, boron fibers or boron-containing fibers can be woven with or into the fiber material from which the belt is made. Alternatively, for example, boron powders can be added in the manufacture of the material from which the belt is then made.

The safety belt according to the invention preferably contains at least 0.1 wt.-% or at least 0.5 wt.-% or at least 1 wt.-% or at least 2.5 wt.-% or at least 5 wt.-% or at least 10 wt.-% or at least 15 wt.-% or at least 25 wt.-% of boron (calculated as the element). The safety belt according to the invention preferably contains at most 50 wt.-% or at most 25 weight.-% or at most 15 wt.-% or more than 5 wt.-% of boron (calculated as the element). These figures relate to the material from which the belt itself (i.e. the flexible part of the belt without the belt buckle and other fasteners) is produced.

A second aspect of the invention is, in addition to the radiation absorbing proofing, to change the design, especially the shape, of the belt compared to the conventional design such that the belt can provide the radiation absorbing effect as effectively as possible, i.e. the largest possible area of particularly sensitive or vulnerable body organs is covered.

With the lap belt conventionally used onboard aircraft, the body is strapped to a seat, said belt being closed with a buckle and running along the bend between thighs and torso of the angled body in the sitting position.

According to the invention, the surface of this conventional belt increased and supplemented, so that a particularly high protective effect against cosmic radiation results. The focus is on the ovaries of woman, so that the location of female ovaries is determinative here.

The ovaries are located left and right of a horizontal imaginary line below the navel. If both hands lie flat on the lower abdomen, with the thumb and the index finger touching each other and the position of the navel being enclosed by the thumb and index fingers, then the palms cover those areas below which the ovaries of a woman are located.

Hence results the widening of the belt according to the invention that ends below the area of the naval and no longer has to cover it.

In one embodiment of the safety belt according to the invention, the widening of the safety belt is effected asymmetrically. Since the lower abdomen is to be protected, the widening of the belt is to the side which is located in front of the torso (an additional protection of the thigh is not envisaged with this approach, so no widening to this side is effected).

Because neutron radiation occurs from all directions, in one embodiment of the invention, a widening of the belt is effected to also allow a lateral shielding of the body.

The belt buckle lies in the body bend between thighs and torso of a seated person. This position of the buckle results from the need to best fix the body mass in the seat in the case of a negative acceleration.

In one embodiment of the invention, the buckle is, in contrast to conventional belts, positioned on top of the cosmic radiation absorbing material of the safety belt, i.e. it is backed by (underlain with) the material.

Other organs of the lower abdomen are also protected against cosmic radiation in this way; in particular, the uterus, an early pregnancy also being encompassed by such protection at the time of maximal rate of cell division. The potential protective effect thus extends to unborn children who are at a particularly critical stage with respect to additional radiation.

The safety belt according to the invention is not only provided for passengers of aircraft (for whom the use of a safety belt is generally obligatory for the entire flight), but also for crew members, in particular the cockpit crew who generally fasten the lap belt during the entire flight. For the crew, in particular the lap belt is designed according to the invention in order to achieve a significant protective effect against cosmic radiation.

It is hardly possible to prove an individual disease being due to exposure to low-level radiation (in this case the neutron proportion of cosmic radiation). It follows that evidence of a protective effect can also not be produced on an individual basis. In the low-radiation range, the expected biological effect is determined by calculation. In this context, there are several statistical approaches that differ from each other in their conclusions. It is common ground though, that the use of radiation-absorbing material, with a simultaneous increase of the screening area, must exert a protective effect.

As a very large number of passengers are involved in today's air traffic worldwide, the relevance of the additional shielding according to the invention results from the multiplication with a large collective.

1. A safety belt for passengers and crew members of aircraft, which has a protective effect against cosmic radiation, wherein the belt is combined with a cosmic radiation absorbing material or such material is incorporated into the belt, wherein the cosmic radiation absorbing material contains boron or a boron-containing material, and wherein the belt is shaped such that, in the fastened state, the belt covers the area of the ovaries of women as completely as possible.

2. The safety belt according to claim 1, wherein boron fibers or boron-containing fibers are woven with or into the fiber material from which the belt is made.

3. The safety belt according to claim 1, wherein boron or boron-containing material is added to the material from which the belt is made.

4. The safety belt according to claim 1, wherein the belt surface is increased by widening, particularly on the sides toward the navel area.

5. The safety belt according to one of the preceding claims, wherein the buckle is backed by cosmic radiation absorbing material.

6. A method for manufacturing safety belts for passengers and crew members of aircraft, wherein the belt is combined with a cosmic radiation absorbing material or such material is incorporated into the belt, wherein the cosmic radiation absorbing material contains boron or a boron-containing material, and wherein boron fibers or boron-containing fibers are woven with or into the material from which the belt is made, or wherein boron or boron-containing material is added to the material from which the belt is made.
